(19) United States
(12) Patent Application Publication
(10) Pub. No.: US 2022/0038147 A1
(43) Pub. Date: Feb. 3, 2022

(54) COMMUNICATION CONTROL METHOD, COMMUNICATION CONTROL DEVICE, AND COMMUNICATION CONTROL PROGRAM

(71) Applicant: Nippon Telegraph and Telephone Corporation, Tokyo (JP)

(72) Inventors: Mitsuki NAKAMURA, Tokyo (JP); Wataru YAMADA, Tokyo (JP); Yasushi TAKATORI, Tokyo (JP)

(21) Appl. No.: 17/297,680

(22) PCT Filed: Nov. 28, 2019
(86) PCT No.: PCT/JP2019/046626

§ 371 Date: May 27, 2021

(30) Foreign Application Priority Data
Dec. 7, 2018 (JP) 2018-230224

(51) Int. Cl. H04B 7/06; H04W 16/28

(52) U.S. Cl. CPC H04B 7/0608; H04W 16/28

(57) ABSTRACT

A communication control method of controlling switching between propagation paths on a receiver side of a wireless communication system having a plurality of propagation paths, the communication control method including: detecting a position of a moving object on the periphery of the propagation paths and a size of the moving object every predetermined time determined in advance; predicting a movement destination of the moving object based on a movement speed and a movement direction of the moving object calculated from the position of the moving object every predetermined time detected in the detecting, and in a case where the propagation path in communication is blocked by the moving object, predicting a blocking ratio of the propagation path; determining whether or not the propagation path in communication needs to be switched to another propagation path based on a result of the prediction acquired in the predicting; and, in accordance with a determination that the propagation path in communication needs to be switched to another propagation path in the determining, switching directivity of an antenna of the receiver.

### TECHNICAL FIELD

The present invention relates to a technology for maintaining stable communication by performing switching among propagation paths before deterioration of communication quality by predicting states of the propagation paths in a wireless communication system including a plurality of propagation paths.

### BACKGROUND ART

In recent years, in the field of wireless communication, the use of high frequency bands of 6 GHz or higher, in which high capacity communication can be performed, has been reviewed due to tightening of frequency resources of 6 GHz or less.

### CITATION LIST

### Patent Literature

Patent Literature 1: JP 2012-103902A

### SUMMARY OF THE INVENTION

### Technical Problem

Generally, in wireless communication using a high frequency band of 6 GHz or higher, communication is performed using a beam having sharp directivity of an antenna for earning a gain at the time of transmission/reception. However, for example, in a case where communication is performed using a beam having sharp directivity of the antenna between fixed stations, a large loss occurs in accordance with blocking of a propagation path due to a blocking object. In particular, in a case where a moving object such as a “person” moves over a propagation path, the propagation path, which was not blocked at the time of starting communication, is blocked during communication. Thus, after deterioration of communication quality occurs, it is necessary to search for another propagation path (another transmitter and frequency, a direction of arrival of radio waves, and the like) and perform re-transmission, and thus there is a problem in that time performance is degraded. Thus, in a communication environment in which a moving object such as a “person” moves within a propagation path, a technology for maintaining stable communication by avoiding blocking of the propagation path is requested.

Meanwhile, while technologies for predicting behaviors of a “person” have been reviewed (for example, see Patent Literature 1), a technology for maintaining stable communication by predicting effects on a communication environment such as blocking of a propagation path and the like and switching to another propagation path before deterioration of communication quality has not been reviewed.

An object of the present invention is to provide a communication control method, a communication control device, and a communication control program capable of maintaining stable communication by predicting deterioration of communication quality of a propagation path and switching to another propagation path before the deterioration of the communication quality.

### Means for Solving the Problem

According to a first invention, there is provided a communication control method of controlling switching between propagation paths on a receiver side of a wireless communication system having a plurality of propagation paths, the communication control method including: detecting a position of a moving object on the periphery of the propagation paths and a size of the moving object every predetermined time determined in advance; predicting a movement destination of the moving object based on a movement speed and a movement direction of the moving object calculated from the position of the moving object every predetermined time detected in the detecting, and in a case where the propagation path in communication is blocked by the moving object, predicting a blocking ratio of the propagation path; determining whether or not the propagation path in communication needs to be switched to another propagation path based on a result of the prediction acquired in the predicting; and, in accordance with a determination that the propagation path in communication needs to be switched to another propagation path in the determining, switching directivity of an antenna of the receiver.

According to a second invention, in the first invention, the determining includes: determining whether or not the propagation path in communication needs to be switched to another propagation path based on the blocking ratio, in a case where there is a likelihood of a plurality of propagation paths being blocked at the same time, correcting and comparing the blocking ratios of the propagation paths based on signal intensities of reception signals when the propagation paths are not blocked, and switching to the propagation path having a low blocking ratio is performed.

According to a third invention, in the first invention or the second invention, the determining includes, in a case where it is predicted that a signal intensity of a reception signal when the propagation path in communication is blocked will be less than a signal intensity of a reception signal in the other propagation paths or less than a predetermined signal intensity determined in advance, determining that switching to another propagation path is necessary.

According to a fourth invention, there is provided a communication control device controlling switching between propagation paths on a receiver side of a wireless communication system having a plurality of propagation paths, the communication control device including: a detecting unit configured to detect a position of a moving object on the periphery of the propagation paths and a size of the moving object every predetermined time determined in advance; a predicting unit configured to predict a movement destination of the moving object based on a movement speed and a movement direction of the moving object calculated from the position of the moving object every predetermined time detected by the detecting unit, and in a case where the propagation path in communication is blocked by the moving object, predicting a blocking ratio of the propagation path; a determining unit configured to determine whether or not the propagation path in communication needs to be switched to another propagation path based on a result of the prediction acquired by the predicting unit; and a switching unit configured to switch, in accordance with a determination that the propagation path in communication needs to be switched to another propagation path by the determining unit, directivity of an antenna of the receiver.

According to a fifth invention, in the fourth invention, the determining unit determines whether or not the propagation path in communication needs to be switched to another propagation path based on the blocking ratio, in a case where there is a likelihood of a plurality of propagation paths being blocked at the same time, corrects and compares the blocking ratios of the propagation paths based on signal intensities of reception signals when the propagation paths are not blocked, and performs switching to the propagation path having a low blocking ratio.

According to a sixth invention, in the fourth invention or the fifth invention, the determining unit determines that switching to another propagation path is necessary in a case where it is predicted that a signal intensity of a reception signal when the propagation path in communication is blocked will be less than a signal intensity of a reception signal in the other propagation paths or less than a predetermined signal intensity determined in advance.

According to a seventh invention, there is provided a program causing a computer to execute a process performed by the communication control device according to any one of the fourth invention to the sixth invention.

### Effects of the Invention

A communication control method, a communication control device, and a communication control program according to the present invention can maintain stable communication by predicting deterioration of communication quality of a propagation path and switching to another propagation path before the deterioration of the communication quality.

### BRIEF DESCRIPTION OF DRAWINGS

FIG. 1 is a diagram illustrating an example of a model in which a propagation path is blocked by a human body.

FIG. 2 is a diagram illustrating an application example of a communication control device according to this embodiment.

FIG. 3 is a diagram illustrating an example of the configuration of a control unit according to this embodiment.

FIG. 4 is a diagram illustrating an example of detection of a moving object and calculation of a speed and a movement direction of the moving object.

FIG. 5 is a diagram illustrating an example of a Fresnel zone.

FIG. 6 is a diagram illustrating an example of calculation of a blocking ratio of a Fresnel zone.

FIG. 7 is a diagram illustrating an example of a case where there is a likelihood of a plurality of propagation paths being blocked.

FIG. 8 is a diagram illustrating an example of a control sequence of a communication control device according to this embodiment.

### DESCRIPTION OF EMBODIMENTS

Hereinafter, a communication control method, a communication control device, and a communication control program according to embodiments of the present invention will be described with reference to the drawings. Here, the communication control method, the communication control device, and the communication control program according to the present invention are applied to a wireless communication system using a high frequency band in which communication can be performed using a plurality of propagation paths. In this embodiment, a function of predicting a movement destination of a moving object through moving object recognition, and in a case where a propagation path that is currently used for communication is blocked, switching from the propagation path in communication to another propagation path is provided. In accordance with this, also in a case where a beam having sharp directivity is used, stable communication can be continuously maintained.

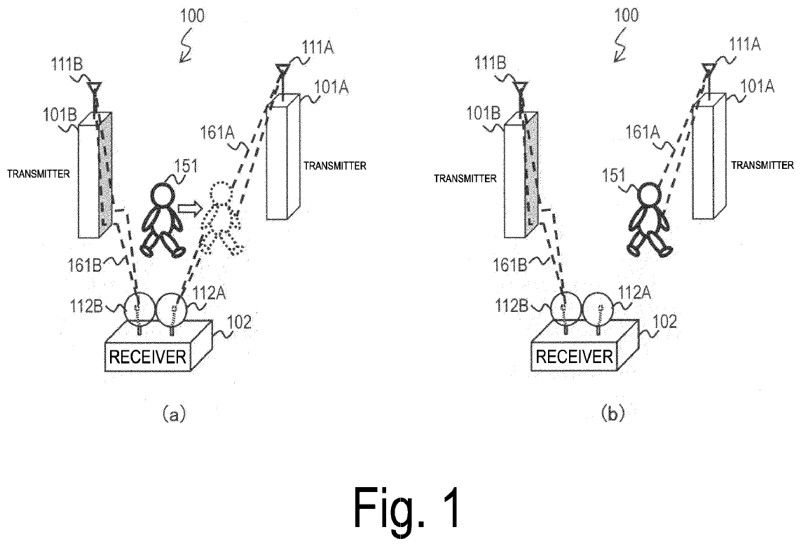

FIG. 1 illustrates an example of a model in which a propagation path is blocked by a human body. FIG. 1(a) illustrates an appearance of the propagation path of a wireless communication system 100 at a certain time, and FIG. 1(b) illustrates an appearance of the propagation path of the wireless communication system 100 after a small amount of time has elapsed from the state illustrated in FIG. 1(a).

In FIG. 1(a), the wireless communication system 100 includes two transmitters including a transmitter 101A and a transmitter 101B and one receiver 102. The transmitter 101A includes an antenna 111A, the transmitter 101B includes an antenna 111B, and the receiver 102 includes an antenna 112A and an antenna 112B. Here, while the receiver 102 includes a plurality of antennas including the antenna 112A and the antenna 112B, the receiver 102 may use the plurality of antennas as an array antenna that can form arbitrary directivity by controlling phases and amplitudes of signals transmitted/received by the plurality of antennas or may control directions of individual antennas. In the example illustrated in FIG. 1(a), the antenna 112A of the receiver 102 is controlled to be in the direction of the antenna 111A of the transmitter 101A, and a propagation path 161A is formed between the antenna 111A and the antenna 112A. Similarly, the antenna 112B of the receiver 102 is controlled to be in the direction of the antenna 111B of the transmitter 101B, and a propagation path 161B is formed between the antenna 111B and the antenna 112B.

Here, in this embodiment, for example, radio waves of a frequency band of 6 GHz or more having high linearity are used. In addition, as a communication environment, for example, a place that a moving object such as a person or a vehicle visits like an event venue or a parking lot is assumed, and there is a likelihood of a propagation path being temporarily blocked by a moving object.

In FIG. 1(a), while the receiver 102 is in communication via the propagation path 161A between the transmitter 101A and the receiver 102, a moving object 151 assumed to be a “person” comes close to the propagation path 161A and has a likelihood of blocking the propagation path 161A. In FIG. 1(b) that illustrates a state after a short time has elapsed (for example, after 5 seconds) from the state illustrated in FIG. 1(a), the moving object 151 blocks the propagation path 161A, and communication disconnection or deterioration of communication quality between the transmitter 101A and the receiver 102 occurs. In this embodiment, in order to avoid the problems described above, by predicting the state illustrated in FIG. 1(b), for example, switching to the propagation path 161B can be performed before there are influences on communication.

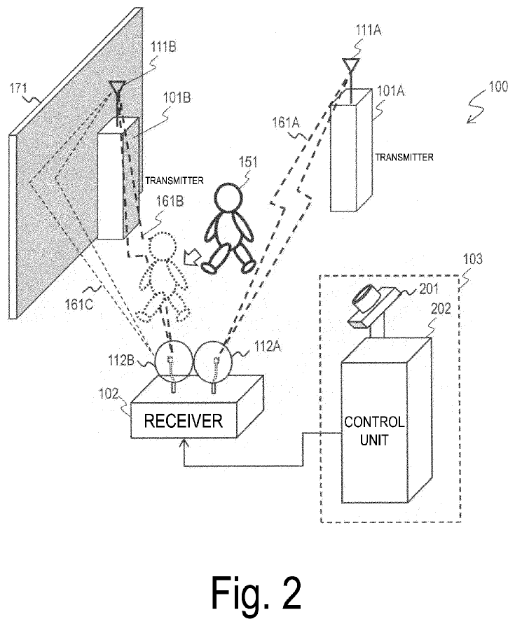

FIG. 2 is a diagram illustrating an application example of a communication control device 103 according to this embodiment. Here, in FIG. 2, units to which the same reference signs as those illustrated in FIG. 1 are assigned represent the same units as those illustrated in FIG. 1. In FIG. 2, a reflective wall 171 is provided near the transmitter 101B, and there is a propagation path 161C in which radio waves transmitted from the antenna 111B of the transmitter 101B are reflected by the reflective wall 171 and reach the antenna 112B of the receiver 102. Thus, the communication control device 103 can select a state in which the directivity of the antenna 112B of the receiver 102 is in a direction of the propagation path 161B in which radio waves are directly received from the antenna 111B of the transmitter 101B and a state in which the directivity of the antenna 112B of the receiver 102 is in a direction of the propagation path 161C in which reflective waves from the reflective wall 171 are received.

In FIG. 2, the communication control device 103 according to this embodiment includes a camera 201 and a control unit 202 and performs control of detecting movement of a moving object 151 and switching to another propagation path before a propagation path in communication is blocked.

The camera 201 captures an image of the periphery of the propagation path 161A, the propagation path 161B, and the propagation path 161C. The image captured by the camera 201 may be either a monochrome image or a color image, and the camera 201 may be a 3D camera capable of acquiring information of a distance to a subject in the captured image. Alternatively, by using a laser scanner or the like instead of the camera 201, information of a position, a size, and the like of a moving object 151 on the periphery of the propagation path 161A, the propagation path 161B, and the propagation path 161C may be acquired. One or a plurality of cameras 201 may be used.

Here, the position of a propagation path is assumed to be acquired in advance through simulation or the like, and it is assumed that a part of an image captured by the camera 201 in which a propagation path is present is perceived in advance. In the example illustrated in FIG. 2, in the control unit 202, information relating to the positions of the propagation path 161A, the propagation path 161B, and the propagation path 161C in the image captured by the camera 201 is stored.

In addition, the control unit 202 may determine the position of each antenna from an image captured by the camera 201 and estimate the position of each propagation path. Furthermore, information relating to positions, heights, and the like of the antenna 111A of the transmitter 101A, the antenna 111B of the transmitter 101B, and the antenna 112 of the receiver 102 may be set in the control unit 202 in advance.

The control unit 202 detects a position and a size of a moving object 151 from an image captured by the camera 201 and acquires information of the position, the size, and the like of the moving object 151 (moving object information) every predetermined time determined in advance. Furthermore, the control unit 202 predicts a movement destination by calculating a movement speed and a movement direction of the moving object 151 based on moving object information acquired every predetermined time and determines whether or not there is a likelihood of the moving object 151 blocking the propagation path in communication. Then, in a case where there is a likelihood of the propagation path being blocked, the control unit 202 performs switching to another propagation path before blocking. Here, in a case where there is a likelihood of a plurality of propagation paths being blocked, the control unit 202 performs a quality evaluation of each of the plurality of propagation paths having a likelihood of being blocked. For example, the quality evaluation is performed using a ratio of the moving object 151 blocking the propagation path (a blocking ratio), a magnitude of a signal intensity of a reception signal received by the receiver 102, and the like. The blocking ratio of the propagation path and the signal intensity of the reception signal received by the receiver 102 will be described below n detail.

In this way, the communication control device 103 according to this embodiment, by combining a moving object recognition technology using an image captured by the camera 201 and a space diversity technology using switching between propagation paths, performs switching to another propagation path in a case where there is a likelihood of the propagation path in communication being blocked, and thus a communication disconnection and deterioration of the communication quality can be avoided in advance.

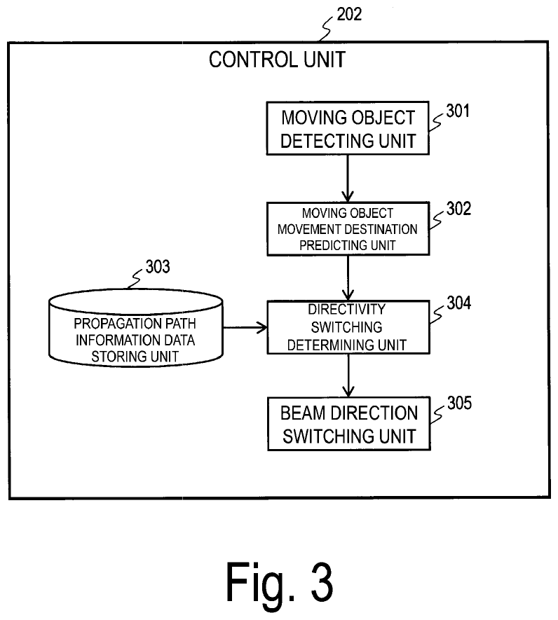

FIG. 3 illustrates an example of the configuration of the control unit 202 according to this embodiment. As illustrated in FIG. 3, the control unit 202 includes a moving object detecting unit 301, a moving object movement destination predicting unit 302, a propagation path information data storing unit 303, a directivity switching determining unit 304, and a beam direction switching unit 305.

The moving object detecting unit 301 detects a position and a size of a moving object 151 from an image captured by the camera 201 every predetermined time. Here, the communication control device 103 uses a frame image output every predetermined time in a case where the camera 201 outputs a moving image and uses a still image captured by instructing the camera 201 every predetermined time in a case where the camera 201 outputs a still image. As a method of detecting a moving object 151, for example, a position of an area in which there is movement in an image can be acquired by acquiring a difference from an image that has been previously acquired and can acquire the size of a moving object 151 by counting the number of pixels of the area in which there is movement. In this way, moving object information such as the position, the size, and the like of the moving object 151 can be acquired.

The moving object movement destination predicting unit 302 predicts a movement destination by calculating a movement speed and a movement direction of the moving object 151 based on the moving object information acquired by the moving object detecting unit 301 every predetermined time. Here, as the prediction of a movement destination, for example, a position after one second, a position after two seconds, . . . are predicted. The process of the moving object movement destination predicting unit 302 will be described below in detail.

The propagation path information data storing unit 303 acquires information of a position and the like of a propagation path that can be used for communication between the transmitter 101A and the transmitter 101B and the receiver 102 (in the example illustrated in FIG. 2, each of the propagation path 161A, the propagation path 161B, and the propagation path 161C) and information of a signal intensity of a signal received by the receiver 102 in a case where the propagation path is not blocked for each propagation path in advance from the receiver 102 and stores the acquired information in an internal memory or the like.

The directivity switching determining unit 304 predicts whether or not the moving object 151 blocks the propagation path in communication based on the information stored by the propagation path information data storing unit 303 and a prediction result acquired by the moving object movement destination predicting unit 302, and in a case where there is a likelihood of the propagation path being blocked, performs switching to another propagation path before blocking.

Here, in a case where there is a likelihood of a plurality of propagation paths being blocked at the same time, the directivity switching determining unit 304 performs a quality evaluation of each of the plurality of propagation paths having a likelihood of being blocked. For example, the quality evaluation is performed using a blocking ratio at a time when a Fresnel zone formed between the antenna of the transmitter and the antenna of the receiver is blocked by the moving object 151. The Fresnel zone is a spatial area that is required for performing communication without any power loss, and a power loss occurs in accordance with the blocking ratio of this area. Then, the directivity switching determining unit 304 compares blocking ratios of a plurality of propagation paths and performs switching to a propagation path having a low blocking ratio. In this case, the blocking ratio may be corrected using a signal intensity of a reception signal received by the receiver 102 at the time of no blocking and be compared with blocking ratios of the other propagation paths. In accordance with this, the directivity switching determining unit 304 can perform switching to a propagation path having a higher signal intensity of a reception signal received by the receiver 102 even in the case of the same blocking ratio, and thus more stable communication can be maintained. The method for acquiring a blocking ratio and the correction method using a signal intensity of a reception signal will be described below in detail.

In addition, not only in a case where there is a likelihood of a plurality of propagation paths being blocked but also in a case where there is a likelihood of one propagation path being blocked, the directivity switching determining unit 304 may acquire a blocking ratio and determine that switching to another propagation path is necessary in a case where the blocking ratio is equal to or higher than a threshold determined in advance.

Alternatively, the directivity switching determining unit 304 may acquire a signal intensity of a reception signal received by the receiver 102 when a propagation path in communication is blocked by a moving object 151, and in a case where it is predicted that the signal intensity is lower than signal intensities of the other propagation paths or is lower than a predetermined signal intensity determined in advance, determine that switching to another propagation path is necessary. Here, the signal intensity of a reception signal received by the receiver 102 at the time of blocking can be estimated by multiplying a signal intensity at the time of no blocking by a blocking ratio.

In this way, the directivity switching determining unit 304 predicts blocking of a propagation path based on the position of the propagation path and the position of the moving object, and in a case where switching to another propagation path is determined to be necessary, instructs the beam direction switching unit 305 to perform switching of the directivity of the antenna.

The beam direction switching unit 305 switches the directivity of the antenna of the receiver 102 such that communication can be performed using another propagation path based on a result of determination acquired by the directivity switching determining unit 304. For example, in FIG. 2, in a case where it is predicted that there is a likelihood of the moving object 151 blocking the propagation path 161B in communication between the transmitter 101B and the receiver 102 via the propagation path 161B, the directivity switching determining unit 304 is controlled to instruct the beam direction switching unit 305 to switch from the antenna 112B of the receiver 102 to the antenna 112A and receive a signal from the transmitter 101A via the propagation path 161A. Alternatively, the directivity switching determining unit 304 switches the directivity of the antenna 112B of the receiver 102 using the beam direction switching unit 305 and performs control such that reflective waves acquired by reflecting a transmission signal of the transmitter 101B on the reflective wall 171 are received via the propagation path 161C. In addition, in the case of switching to the propagation path 161C, when a small amount of time elapses, again, it is predicted that there is a likelihood of the moving object 151 blocking the propagation path 161C. In this case, the directivity switching determining unit 304 performs control such that a signal is received via the propagation path 161B by instructing the beam direction switching unit 305, for example, to switch the directivity of the antenna 112B of the receiver 102 to the direction of the propagation path 161B after passage of the moving object 151. Alternatively, the directivity switching determining unit 304 may perform control such that a signal is received from the transmitter 101A via the propagation path 161A by switching from the antenna 112B of the receiver 102 to the antenna 112A. Here, the transmitter 101A and the transmitter 101B perform communication of the same details with the receiver 102.

In this way, the communication control device 103 according to this embodiment, in a case where it is predicted that there is a likelihood of a propagation path in communication being blocked, switches to another propagation path in which satisfactory communication can be performed before the propagation path is blocked by performing switching of directivity of the antenna of the receiver 102 (including switching of the antenna), and thus stable communication can be maintained.

Here, although the communication control device 103 according to this embodiment has been described as a device that includes each block illustrated in FIG. 3, it can be also realized by a computer that executes a program corresponding to the process performed by each block. Note that the program may be provided being recorded on a recording medium, or may be provided via a network.

Next, the process of the moving object movement destination predicting unit 302 will be described in detail.

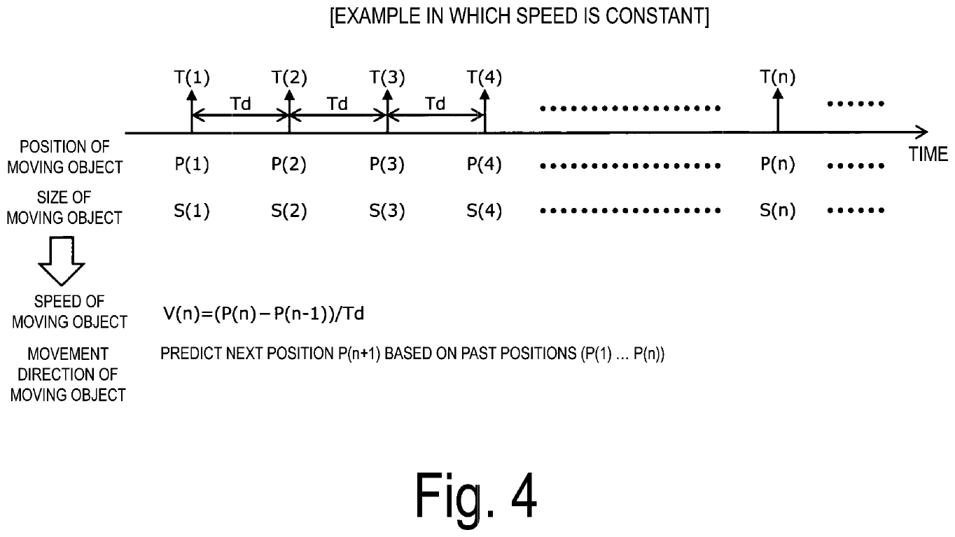

FIG. 4 illustrates an example of detection of a moving object and calculation of a speed and a movement direction of the moving object. In FIG. 4, the horizontal axis represents time.

In FIG. 4, the moving object detecting unit 301 acquires a position and a size of a moving object every predetermined time Td determined in advance from an image captured by the camera 201. In the example illustrated in FIG. 4, a position P(1) of a moving object and a size S(1) of the moving object are acquired at a time T(1). Similarly, the moving object detecting unit 301 acquires a position of the moving object and a size of the moving object every predetermined time Td, as in a position P(2) of the moving object and a size S(2) of the moving object at a time T(2), a position P(3) of the moving object and a size S(3) of the moving object at a time T(3), a position P(4) of the moving object and a size S(4) of the moving object at a time T(4), . . . , and a position P(n) of the moving object and a size S(n) of the moving object at a time T(n).

Then, the moving object movement destination predicting unit 302 predicts a speed of the moving object and a movement direction of the moving object from the position of the moving object and the size of the moving object at every predetermined time Td. For example, the speed V(n) at which the moving object moves can be acquired using the following equation from the position P(n) of the moving object at a time T(n) and the position P(n−1) of the moving object at a time T(n−1).

V(n)=(P(n)−P(n−1))/Td (1)

Here, for example, a position P of a moving object is represented by coordinates (x, y) in a two-dimensional image captured by the camera 201 or coordinates (x, y, z) in a three-dimensional space in a case where a z coordinate in a depth direction is acquired using a 3D camera, a 3D scanner, or the like, and (P(n)−(P(n−1)) represented in Equation (1) corresponds to a distance between two points of two-dimensional coordinates or two points of three-dimensional coordinates.

In addition, in a movement direction of the moving object, a next position P(n+1) of the moving object can be predicted based on past positions (P(1), P(2), P(3), P(4), . . . , P(n)) of the moving object. The prediction of a position of the moving object is performed on two-dimensional coordinates in a case where the position of the moving object is acquired in two-dimensional coordinates and is performed on three-dimensional coordinates in a case where the position of the moving object is acquired in three-dimensional coordinates.

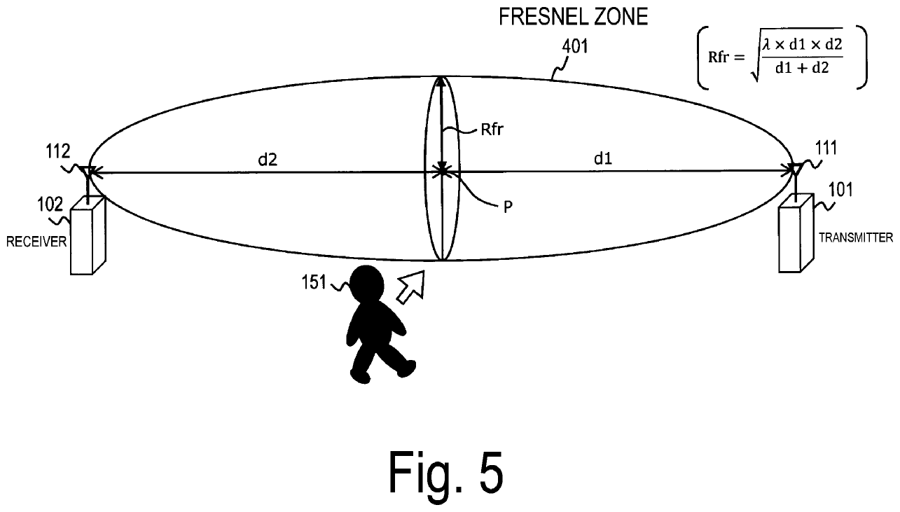

Regarding Blocking Ratio FIG. 5 illustrates an example of a Fresnel zone 401. In FIG. 5, the radius Rfr of the Fresnel zone 401 between the antenna 111 of the transmitter 101 and the antenna 112 of the receiver 102 is given in the following equation.

$$\begin{matrix}[ Math . 1 ] & \\ Rfr = \sqrt{\frac{λ \times d 1 \times d 2}{d 1 + d 2}} & ( 2 )\end{matrix}$$

Here, λ represents a wavelength of radio waves, d1 represents a distance from the antenna 111 of the transmitter 101 to a blocking point P of the moving object 151, and d2 represents a distance from the antenna 112 of the receiver 102 to the blocking point P.

In FIG. 5, when the moving object 151 enters the Fresnel zone 401, a signal intensity of a reception signal received by the antenna 112 of the receiver 102 decreases, and there is a likelihood of an error ratio becoming worse or communication disconnected in the worst case. Thus, the communication control device 103 according to this embodiment calculates a ratio (blocking ratio) at which the Fresnel zone 401 is blocked by the moving object 151 and determines whether or not switching of the propagation path is necessary.

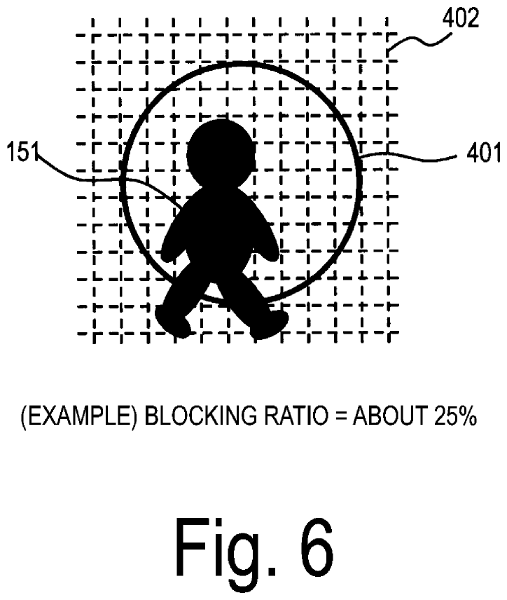

FIG. 6 illustrates an example of calculation of a blocking ratio of the Fresnel zone 401. Here, FIG. 6 illustrates a cross-section of the Fresnel zone 401 at the blocking point P when a direction from the transmitter 101 to the receiver 102 (or a direction from the receiver 102 to the transmitter 101) is seen in FIG. 5 and illustrates an example when the moving object 151 enters the Fresnel zone 401.

Here, when the distance d1 from the antenna 111 of the transmitter 101 to the blocking point P of the moving object 151 and the distance d2 from the antenna 112 of the receiver 102 to the blocking point P of the moving object 151 are acquired from the image of the camera 201, the radius Rfr of the Fresnel zone 401 at the blocking point P of the moving object 151 can be calculated using Equation (2). The area Sfr of the Fresnel zone 401 is acquired using the following equation. Here, π is a circumference ratio.

Sfr=π×(Rfr)² (3)

Here, in FIG. 6, as an area Sd of a portion of the moving object 151 that blocks the Fresnel zone 401, it is only required that an area of a portion of the moving object 151 that is projected on the cross-section of the Fresnel zone 401 be acquired. For example, as illustrated in FIG. 6, the Fresnel zone 401 at a position that the moving object 151 enters is set as a mesh 402 and is divided into a plurality of squares, and the area Sd of the portion of the moving object 151 blocking the Fresnel zone 401 is acquired using the following equation based on the number Mf of the squares within the Fresnel zone 401 and the number Md of squares of an area occupied by the moving object 151 within the Fresnel zone 401. By using smaller squares, the accuracy can be raised even for a moving object 151 having a complex shape.

Sd=Sfr×Md/Mf (4)

The blocking ratio K % at this time is acquired using the following equation.

K=Md/Mf×100 (5)

For example, in the case of FIG. 6, the number Mf of squares of the mesh 402 within the Fresnel zone 401 is about 64, and the number Md of squares of the portion of the moving object 151 is about 16, and thus the blocking ratio K is K=16/64×100=25%.

In this way, the communication control device 103 according to this embodiment can acquire a blocking ratio of a propagation path according to a moving object 151 in accordance with a position and a size of the moving object 151 predicted to enter a Fresnel zone 401 by assuming a propagation path as the Fresnel zone 401.

Correction of Blocking Ratio Next, an example in which a blocking ratio is corrected in accordance with a signal intensity of a reception signal received by the receiver 102 in a case where there is no blocking object will be described.

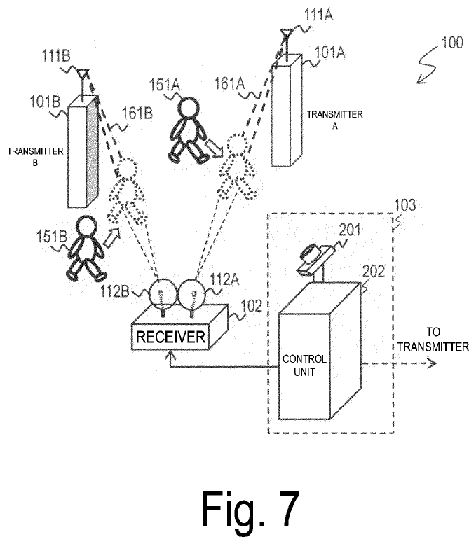

FIG. 7 illustrates an example of a case where there is a likelihood of a plurality of propagation paths being blocked. In FIG. 7, blocks with the same reference signs as those illustrated in FIG. 2 operate similar to the case of FIG. 2.

In FIG. 7, a case where there is a likelihood of two propagation paths including a propagation path 161A between a transmitter 101A and a receiver 102 and a propagation path 161B between a transmitter 101B and a receiver 102 being blocked by a moving object 151A and a moving object 151B at the same time will be considered. In such a case, the communication control device 103 corrects blocking ratios in accordance with signal intensities of reception signals received by the receiver 102 at the time of blocking a plurality of propagation paths and compares corrected blocking ratios with each other. The blocking ratio of each propagation path is calculated using the method described with reference to FIG. 6.

Here, for example, in FIG. 7, in a case where the blocking ratio of the propagation path 161A is predicted to be Ka and the blocking ratio of the propagation path 161B is predicted to be Kb, the communication control device 103 performs a correction process based on a signal intensity Pa of the reception signal in the propagation path 161A and a signal intensity Pb of the reception signal in the propagation path 161B in a case where there is no blocking object. It is assumed that the signal intensity of the reception signal in each propagation path in a case where there is no blocking object is acquired from the receiver 102 and is stored in advance. Alternatively, at a time point at which it is determined that there is a likelihood of a propagation path being blocked by a moving object, a state in which there is no blocking object yet in the propagation path is formed. Thus, the communication control device 103 may acquire a signal intensity of the reception signal in the receiver 102 at this time point.

For example, in a case where the blocking ratio Kb of the propagation path 161B is corrected with reference to the signal intensity Pa of the propagation path 161A, a blocking ratio Kb′ of the propagation path 161B after correction is acquired using the following equation.

Kb′=Kb×Pb/Pa (6)

Then, the communication control device 103 compares the blocking ratio Ka of the propagation path 161A with the blocking ratio Kb′ of the propagation path 161B after correction and selects the propagation path having the lower blocking ratio.

On the other hand, in a case where the blocking ratio Ka of the propagation path 161A is corrected with reference to the signal intensity Pb of the propagation path 161B, a blocking ratio Ka′ of the propagation path 161A after correction is acquired using the following equation.

Ka′=Ka×Pa/Pb (7)

Then, the communication control device 103 compares the blocking ratio Ka′ of the propagation path 161A after correction with the blocking ratio Kb of the propagation path 161B and selects the propagation path having the lower blocking ratio.

In this way, the communication control device 103 according to this embodiment corrects a blocking ratio of a propagation path based on a signal intensity in a case where there is no blocking object, and thus a propagation path in which more stable communication can be performed can be selected also in a case where the blocking ratios of propagation paths are the same.

In addition, although the communication control device 103 corrects blocking ratios based on signal intensities and compares the blocking ratios after correction with each other in the example described above, a propagation path may be selected by acquiring signal intensities at a time at which propagation paths are blocked from the blocking ratios and comparing signal intensities at the time at which the propagation paths are blocked. For example, in FIG. 7, when the signal intensity of the reception signal of the propagation path 161A in a case where there is no blocking object is denoted by Pa, the signal intensity of the reception signal of the propagation path 161B in a case where there is no blocking object is denoted by Pb, a blocking ratio at the time at which the propagation path 161A is blocked by the moving object 151A is denoted by Ka (%), and a blocking ratio at the time at which the propagation path 161B is blocked by the moving object 151B is denoted by Kb (%), a signal intensity Pa′ at the time at which the propagation path 161A is blocked by the moving object 151A is acquired using the following equation.

Pa′=Pa×Ka/100 (8)

Similarly, a signal intensity Pb′ at the time at which the propagation path 161B is blocked by the moving object 151B is acquired using the following equation.

Pb′=Pb×Kb/100 (9)

Then, the signal intensity Pa′ at the time at which the propagation path 161A is blocked by the moving object 151A is compared with the signal intensity Pb′ at the time at which the propagation path 161B is blocked by the moving object 151B, and the propagation path having the higher signal intensity is selected. Although the signal intensities at the time at which both the propagation path 161A and the propagation path 161B are blocked are compared with each other the example described above, a signal intensity of a propagation path having a likelihood of being blocked and a signal intensity of a propagation path that is not blocked may be compared with each other. In such a case, for example, in a case where a signal intensity of a case where a propagation path in communication is blocked is higher than a signal intensity of another propagation path that has not been blocked, communication on the propagation path in communication is maintained without performing switching to another propagation path that has not been blocked.

In this way, in a case where there is a likelihood of a plurality of propagation paths being blocked at the same time, the communication control device 103 according to this embodiment selects a propagation path having a higher signal intensity of a reception signal, and thus more stable communication can be maintained.

Hereinafter, the flow of processes of the communication control device 103 according to this embodiment will be described.

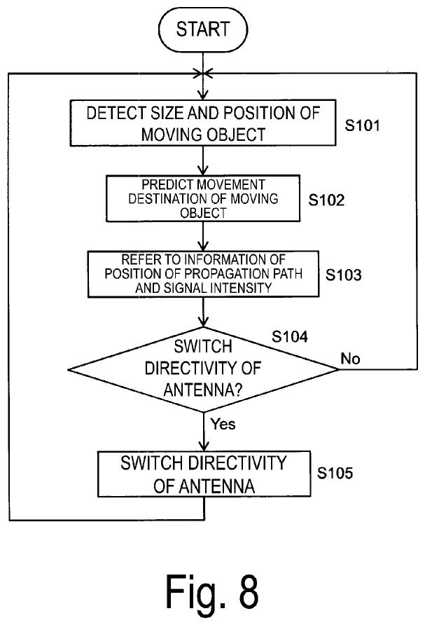

FIG. 8 illustrates an example of a control sequence of the communication control device according to this embodiment. For example, the processes illustrated in FIG. 8 are executed by the control unit 202 described with reference to FIG. 3.

In step S101, the moving object detecting unit 301 performs a process of detecting a position and a size of a moving object 151 from an image captured by the camera 201 every predetermined time (detection process).

In step S102, the moving object movement destination predicting unit 302 performs a process of predicting a movement destination of a moving object 151 based on a speed and a movement direction of the moving object 151 detected by the moving object detecting unit 301 (prediction process).

In step S103, the directivity switching determining unit 304 reads and refers to information of positions of propagation paths (the propagation path 161A and the propagation path 161B) that can be used for communication between the transmitter 101A and the transmitter 101B and the receiver 102 and signal intensities of signals received by the receiver 102 from the transmitter 101A or the transmitter 101B from the propagation path information data storing unit 303.

In step S104, the directivity switching determining unit 304 performs a process of predicting whether or not a propagation path in communication is blocked by the moving object 151 based on the information from the propagation path information data storing unit 303 and a result of the prediction acquired in step S102 and determining whether or not switching to another propagation path is necessary (determination process). Then, in accordance with a determination that switching to another propagation path is necessary, the directivity switching determining unit 304 causes the process to proceed to the process of step S105 and, in accordance with a determination that switching to another propagation path is not necessary, causes the process to return to the process of step S101 and the same process to be repeatedly executed.

In step S105, the beam direction switching unit 305 performs a process of switching the directivity of the antenna of the receiver 102 such that communication can be performed using another propagation path based on a result of the determination acquired by the directivity switching determining unit 304 (switching process).

In this way, the communication control device 103 according to this embodiment can switch the directivity of the antenna of the receiver 102 by predicting whether or not a moving object 151 blocks the propagation path and determining whether or not switching to another propagation path is necessary. In this way, even in a case where a beam having sharp directivity is used, stable communication can be continuously maintained.

As described in each of the embodiments above, the communication control method, the communication control device, and the communication control program according to the present invention can maintain stable communication by predicting deterioration of communication quality of a propagation path and switching to another propagation path before deterioration.

### REFERENCE SIGNS LIST

100 Wireless communication system
101, 101A, 101B Transmitter
102 Receiver
103 Communication control device
111, 111A, 111B, 112, 112A, 112B Antenna
151, 151A, 151B Moving object
161A, 161B, 161C Propagation path
171 Reflective wall
201 Camera
202 Control unit
301 Moving object detecting unit
302 Moving object movement destination predicting unit
303 Propagation path information data storing unit
304 Directivity switching determining unit
305 Beam direction switching unit
401 Fresnel zone
402 Mesh

1. A communication control method of controlling switching between propagation paths on a receiver side of a wireless communication system having a plurality of propagation paths, the communication control method comprising:
detecting a position of a moving object on a periphery of the plurality of propagation paths and a size of the moving object at every predetermined time determined in advance;
predicting a movement destination of the moving object based on a movement speed and a movement direction of the moving object calculated from the position of the moving object at every predetermined time detected in the detecting, and in a case where the propagation path that is in communication is blocked by the moving object, predicting a blocking ratio of the propagation path;
determining whether or not the propagation path that is in communication needs to be switched to another propagation path of the plurality of propagation paths based on a result of a prediction acquired in the predicting, and
in accordance with a determination that the propagation path that is in communication needs to be switched to another propagation path in the determining, switching directivity of an antenna of the receiver.

2. The communication control method according to claim 1, wherein the determining includes:
determining whether or not the propagation path that is in communication needs to be switched to another propagation path based on the blocking ratio,
in a case where there is a likelihood of a set of propagation paths of the plurality of propagation paths being blocked at the same time, correcting and comparing the blocking ratios of the set of propagation paths based on signal intensities of reception signals when the set of propagation paths are not blocked, and
switching to a propagation path having a low blocking ratio is performed.

3. The communication control method according to claim 1, wherein the determining includes, in a case where it is predicted that a signal intensity of a reception signal when the propagation path that is in communication is blocked is less than a signal intensity of a reception signal in the other propagation path of the plurality of propagation paths or less than a predetermined signal intensity that is determined in advance, determining to switch to another propagation path.

4. A communication control device configured to control switching between propagation paths on a receiver side of a wireless communication system having a plurality of propagation paths, the communication control device comprising:
a detecting unit, including at least one processor, configured to detect a position of a moving object on a periphery of the plurality of propagation paths and a size of the moving object at every predetermined time determined in advance;
a predicting unit, including at least one processor, configured to predict a movement destination of the moving object based on a movement speed and a movement direction of the moving object calculated from the position of the moving object at every predetermined time detected by the detecting unit, and in a case where the propagation path that is in communication is blocked by the moving object, predict a blocking ratio of the propagation path;
a determining unit, including at least one processor, configured to determine whether or not the propagation path that is in communication needs to be switched to another propagation path of the plurality of propagation paths based on a result of a prediction acquired by the predicting unit; and
a switching unit, including at least one processor, configured to switch, in accordance with a determination that the propagation path that is in communication needs to be switched to another propagation path of the plurality of propagation paths by the determining unit, directivity of an antenna of the receiver.

5. The communication control device according to claim 4, wherein the determining unit determines whether or not the propagation path that is in communication needs to be switched to another propagation path based on the blocking ratio, in a case where there is a likelihood of a set of propagations paths of the plurality of propagation paths being blocked at the same time, corrects and compares the blocking ratios of the set of propagation paths based on signal intensities of reception signals when the set of propagation paths are not blocked, and performs switching to a propagation path having a low blocking ratio.

6. The communication control device according to claim 4, wherein the determining unit determines that switching to another propagation path is necessary in a case where it is predicted that a signal intensity of a reception signal when the propagation path that is in communication is blocked is less than a signal intensity of a reception signal in other propagation paths or less than a predetermined signal intensity determined in advance.

7. A non-transitory computer readable medium comprising a communication control program that causes a computer to serve as a communication control device comprising:
a detecting unit configured to detect a position of a moving object on a periphery of the plurality of propagation paths and a size of the moving object at every predetermined time determined in advance;
a predicting unit configured to predict a movement destination of the moving object based on a movement speed and a movement direction of the moving object calculated from the position of the moving object at every predetermined time detected by the detecting unit, and in a case where the propagation path that is in communication is blocked by the moving object, predict a blocking ratio of the propagation path;
a determining unit configured to determine whether or not the propagation path that is in communication needs to be switched to another propagation path of the plurality of propagation paths based on a result of a prediction acquired by the predicting unit; and
a switching unit configured to switch, in accordance with a determination that the propagation path that is in communication needs to be switched to another propagation path of the plurality of propagation paths by the determining unit, directivity of an antenna of the receiver.
